(19) United States
(12) Patent Application Publication
(10) Pub. No.: US 2008/0309178 A1
(43) Pub. Date: Dec. 18, 2008

(54) Geared Motor

(75) Inventor: Andreas Roither, Enger (DE)

Correspondence Address: BARNES & THORNBURG LLP, 750-17TH STREET NW, SUITE 900, WASHINGTON, DC, 20006-4675, US

(73) Assignee: DEWERT ANTRIEBS- UND SYSTEMTECHNIK GMBH, Kirchlengern (DE)

(21) Appl. No.: 11/996,096

(22) PCT Filed: Jul. 10, 2006
(86) PCT No.: PCT/EP2006/064064

§ 371 Date: Feb. 5, 2008

(30) Foreign Application Priority Data
Jul. 20, 2005 (DE) 20 2005 011 632.7

(51) Int. Cl. H02K 7/10

(52) U.S. Cl. 310/77

(57) ABSTRACT

A geared motor, for driving an adjusting mechanism, that is drivingly coupled thereto. The geared motor comprises a driving motor and at least one gear stage for reducing the motor speed. A drive unit formed by said parts is disposed in a monolithic or multipiece housing. The drive unit includes a mechanical load moment lock which is effectively connected to a gear stage and is functionally coupled to an output member of a gear stage. The load moment lock is coupled to the output member of the first gear stage that is connected downstream from the driving motor. The load moment lock is embodied as a monolithic and annular spring element.

### BACKGROUND AND SUMMARY

The present disclosure relates to a geared motor, in particular for driving an adjusting device, which is coupled thereto in terms of drive, for furniture components. The geared motor comprises a driving motor, at least one gear stage, which is formed from gear components, for reducing the motor speed, and with a single- or multi-part housing.

The geared motor under discussion is considered an extremely small drive, since the power is significantly below 1 kW. In a preferred embodiment, the geared motor is used in order to adjust an adjusting device for items of furniture, for example a slatted frame, a bed or part of a bed, or an armchair. Geared motors of this type are customarily provided with a gear stage. The gear stage comprises a worm which can be driven by the driving motor and a worm wheel meshing with the worm. The worm wheel then serves as a driving element for a drive train. The drive train may comprise a spindle which can be driven by the worm wheel, and a spindle nut which is placed on to the spindle and is secured against rotation. However, the driving wheel could also have an internal threaded bore into which a spindle is inserted. The spindle could be secured against rotation such that the entire geared motor including the gear stage moves on the spindle. Drives of this type are referred to as linear drives. However, it is also possible that the worm wheel drives a shaft, and therefore the drive is a rotational drive. However, it is also possible that a further gear stage is connected downstream of the worm wheel.

The drive trains are preferably designed in such a manner that the drive is self-locking, i.e. a load moment which is in effect is maintained when the driving motor is switched off. However, the drives under discussion require relatively great adjustment speeds and/or relatively large adjustment loads which result in the drive train no longer being self-locking. Braking elements are then integrated into the drive train, the braking elements are designed in such a manner that the load which is in effect is maintained when the driving motor is switched off. Although such solutions have proven successful, they are complicated structurally and are an obstacle to the requirement for a compact construction. The drives and geared motors under discussion should always be of extremely compact design, since the installation spaces are relatively small.

The present gear motor is based on the object of providing a geared motor which is designed simply structurally and which is extremely compact and to which different drive trains which are not themselves able to be self-locking can be connected.

The object set is achieved by a mechanical load moment lock being operatively connected to a gear stage of the geared motor.

The load moment lock is now integrated into the geared motor, and therefore the drive train connected downstream is formed exclusively from the components present. It is particularly advantageous if the load moment lock is operatively connected to the output element of the first gear stage connected downstream of the driving motor. It is furthermore particularly advantageous if the load moment lock is designed as a spring element, preferably is designed as a single-piece and annular spring element. This takes into account the fact that, in the preferred exemplary embodiment, the output element of each gear stage is a rotating gear component.

A structurally simple solution, also with regard to the torques to be transmitted, arises if the braking element is designed as a spring element with a plurality of coils.

The spring element may then be designed in such a manner that it expands in one rotational direction of the associated output element and therefore generates a braking force. However, it may also be designed in such a manner that it expands in one rotational direction of the output element and contracts in the other rotational direction. In the process, the braking force may be increased or reduced.

It is furthermore provided that a cylindrical attachment or at least two webs lying on a circle is or are fitted to or integrally formed on the output element of the respective gear stage. The spring element is placed onto the attachment or onto the webs or in that the attachment or the webs is/are operatively connected to the load moment lock.

In many embodiments of the geared motor under discussion, the housing is manufactured from a plastic. It is therefore provided, in a further refinement, that the braking element or the spring element is inserted into a ring of a metallic material. However, the ring may be omitted if the housing is composed of metal, for example of steel.

According to another embodiment, it is provided that the output element of the gear stage equipped with the braking element is connected in a rotationally fixed manner to a bushing, and that the spring element is placed onto the bushing. It is furthermore provided that a respective rolling contact bearing is arranged in the housing, on both sides of the output element. In a further refinement, it is provided that the housing which accommodates the motor and the gear components, is of single-piece design. However, it is likewise conceivable that the housing part which accommodates the driving motor and the housing part which accommodates the gear components are screwed or otherwise joined to each other.

In a further embodiment, it is also provided that a switchable clutch, for example a claw clutch, is arranged between the output element of the gear stage equipped with the braking element or of a following gear stage and the drive train connected downstream. In this case, the clutch may be switched manually and/or electrically and/or may switch itself automatically. In the last-mentioned case of automatic switching, the claws are designed in the manner of serrations such that the force is transmitted only in one rotational direction, and therefore the claw clutch acts as a free wheel. Depending on the design of the drive train, a connecting part can be fitted to or integrally formed on the housing which accommodates the gear components. The connecting part would be connected, for example, fixedly to the housing. As a result, said housing could be flanged to another housing part or to an item of furniture.

The geared motor under discussion may be used as a driving element for very different adjusting devices. It is therefore also provided, in a further refinement, that the gear stage having the braking element is assigned a free wheel. The free wheel could be designed, in turn, as a spring element. As a result, it would be possible that, for example, the lowering of a connected component can take place when the driving motor is switched off.

Irrespective of the particular design of the geared motor, the drive is designed in such a manner that all of the forces are removed via the housing.

The housing of the geared motor comprises at least one shaped part. In this case, a plurality of shaped parts can be connected to one another such that the gear housing is designed as a closed housing. The abutting surfaces of the housing can be provided with sealing elements in order to avoid, for example, penetration of liquids and solids into the interior of the housing. In a further embodiment, the gear housing comprises at least one web-like, open structure. It is possible for a plurality of structures to be constructed and assembled in the form of a lattice. In this embodiment, the sealing of the housing parts can be omitted, since a further housing is pulled over the gear housing in order to protect the gear and the gear components against dirt and moisture.

Depending on the particular application of the geared motor, the housing of the geared motor is provided with attachments and/or recesses in order to fix a further drive train to the geared motor and/or in order to fasten the geared motor on or in an item of furniture or on or in a first furniture component.

In this case, the drive train which is fitted to the gear housing is preferably formed by a spindle drive which is formed from at least one threaded spindle, a spindle nut placed thereon and a furniture component operatively connected thereto. In this case, the first and second furniture components are moved relative to each other by the geared motor. In another embodiment, the output element of the geared motor is provided with a profiled internal bore. The profiled internal bore can be formed by an internal threaded section and/or by a polygonal profile, for example in the form of a hexagonal socket. In a development of this embodiment, the housing of the geared motor is provided with at least one opening through which is guided a threaded spindle or a profiled rod which is operatively connected to the profiled internal bore of the output element of the geared motor.

In the case of the previously described geared motor, the housing or at least one housing part is provided with attachments and/or recesses. As a result, webs, forks, journals or recesses with transverse bores can be fitted to/provided on or integrally formed on the gear housing in order to fix the geared motor on or in an item of furniture or in a furniture component. Furthermore, bores, recesses, pockets or journals can also be fitted to/provided on or integrally formed on the gear housing or parts of the gear housing in order to fasten a drive train, for example in the form of a threaded spindle drive, to the gear housing.

The load moment lock mentioned at the beginning is formed by a driving body, an output body, a braking body and a frictional body. In this case, the driving body, the output body and the braking body are mounted in a rotating manner while the frictional body is connected fixedly to the gear housing or is formed by a section of the gear housing. In a preferred embodiment, the driving body is formed by a worm wheel and the braking body is formed by a braking spring, comprising a helically coiled wire section with angled wire ends. The output body is operatively connected to a clutch, a threaded spindle, a profiled rod or a train of gears connected downstream. In this case, the outside diameter of the braking body is somewhat larger than the inside diameter of the frictional body, and therefore the braking body can be fitted to the frictional body under a spring prestress.

The driving body and the output body have claws which engage in one another. A play is provided circumferentially between the claws such that the driving body and the output body can move relative to each other by a corresponding angle. The claws are operatively connected here to the angled end sections of the braking spring in the manner of a driver. The claws of the driving body are operatively connected irrespective of the rotational direction to first surfaces of the angled end sections in such a manner that the spring prestressing described at the beginning is reduced.

The claws of the output body are operatively connected to the second surfaces of the angled end sections of the braking body in such a manner that, upon a rotation from the direction of the output element connected downstream of the output body, a reinforcement of the spring prestress takes place, thereby increasing the friction between the braking body and the frictional body.

The components used are usually manufactured from a plastic. A further embodiment therefore provides that the claws of the driving body and/or of the output body, at least in the region of contact with the first and/or the second surfaces of the angled end sections of the braking element, inserts of a higher strength material, for example metal inserts, are inserted into or fitted to the claws.

### BRIEF DESCRIPTION OF THE DRAWINGS

The invention is explained in more detail with reference to the attached drawings, in which:

FIG. 1 shows a geared motor within a drive train which has a linear output element;

FIG. 2 shows the geared motor according to FIG. 1 in a sectional illustration, with the intersection line running through the output element of the driving stage;

FIG. 3 shows the geared motor according to FIGS. 1 and 2 in an exploded illustration;

FIG. 4 shows a variant of the geared motor according to FIGS. 1 to 3 with a free wheel in an exploded illustration;

FIG. 5 shows one possible embodiment of the housing of the geared motor;

FIG. 6 shows an illustration corresponding to FIG. 5, but showing the housing which accommodates the gear components in a sectional illustration;

FIG. 7 shows an illustration corresponding to FIG. 6, but in vertical section;

FIGS. 8 and 10 show the geared motor according to FIGS. 5 to 7, in which a threaded spindle is driven, and

FIG. 11 shows an illustration of a varint corresponding to FIG. 7.

### DETAILED DESCRIPTION OF THE DRAWINGS

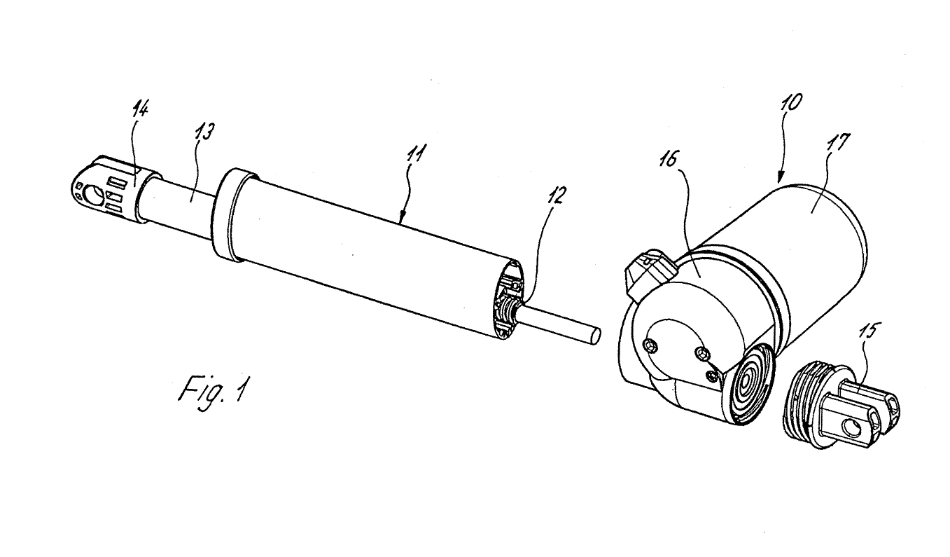

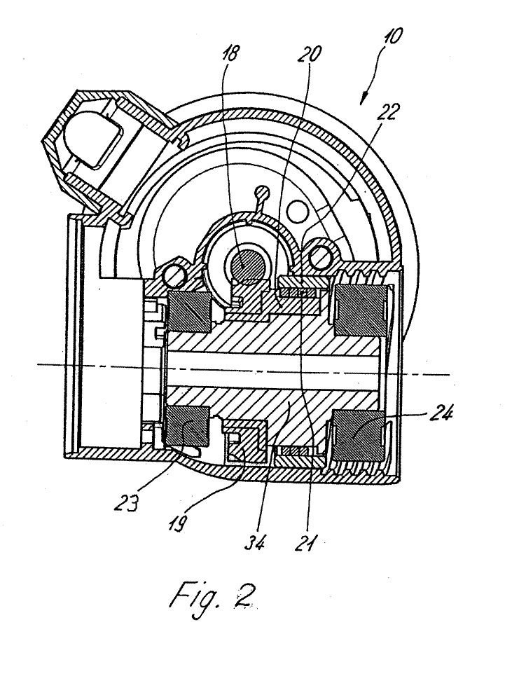

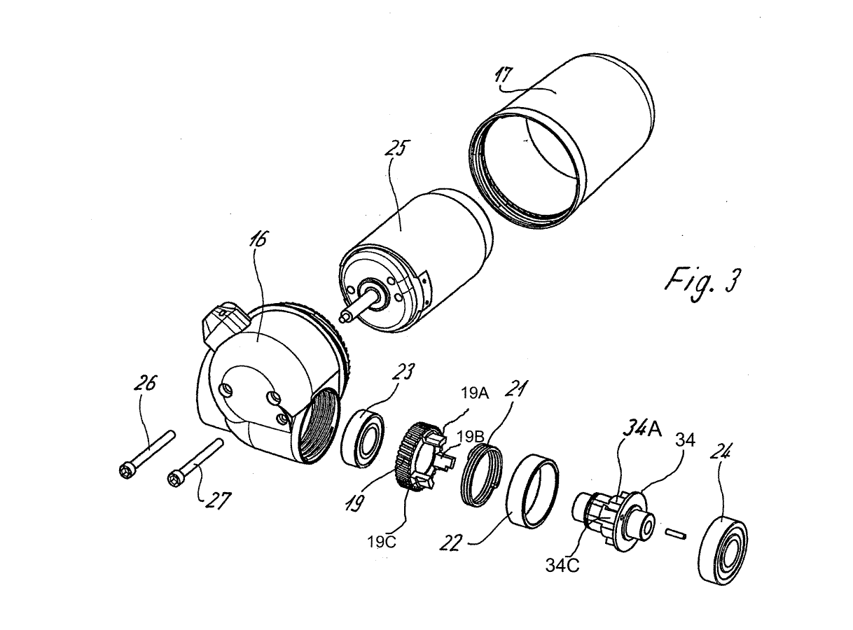

FIG. 1 illustrates a geared motor 10 which is also explained in more detail with reference to FIGS. 2 and 3. The geared motor 10 is designed for driving a linear unit 11 which is equipped with a spindle 12 which can be driven in a rotating manner. A spindle nut, (not shown), which is secured against rotation and, accordingly, is movable in the longitudinal direction of the spindle 12 depending on the rotational direction. A lifting tube 13, which can be coupled via a fork head 14 to a component to be adjusted, is coupled to the spindle nut. The geared motor 10 is equipped with a further connecting part in the form of a fork head 15. This fork head 15 bears a threaded attachment which is screwed into a corresponding mating thread of the geared motor 10. In the exemplary embodiment illustrated, the fork head 15 is screwed into the housing part 16 which accommodates the gear component. The housing part 16 is connected fixedly, for example by screws, to a housing part 17 which accommodates the driving motor. In contrast to the embodiment illustrated, the housing for accommodating the driving motor and for accommodating the gear components could be of single-piece design. Furthermore, instead of the linear unit 11, a component which can be driven in a rotating manner could be connected to the geared motor 10, and therefore, for example, a shaft or a profiled bar could be driven.

FIG. 2 shows one possible embodiment of the gear mechanism according to FIG. 1. According thereto, a worm 18 is driven by the driving motor. The worm 18, meses with, a worm wheel 19, which is placed in a rotationally fixed manner onto a bushing 20 of step-shaped design. In a preferred embodiment, the worm wheel 19 and the bushing 20 may be designed as a single-piece shaped part.

The gear mechanism is also equipped with a load moment lock in the form of a braking spring 21 which comprises a plurality of coils. The braking spring 21 is inserted into a bushing 22. The gear mechanism is designed in such a manner that, when an adjustment force bears on the fork head 14, the braking spring 21 expands and thus produces a braking force. According to the illustration of FIG. 2, the fork head 15 is screwed in, in the right-hand part of the housing part 16. The gear mechanism furthermore has an output body 34 which is provided with a bore running transversely with respect to the worm 18. The braking spring 21 can be inserted into the bore in a manner not illustrated specifically. The output body 34 is mounted in the housing part 16 by means of two rolling contact bearings 23, 24. As FIGS. 2 and 3 show, the braking spring 21 is formed from a wire section with a square cross section, and therefore the corresponding braking surfaces are to be regarded as solid. In this case, each wire end is angled.

FIG. 3 illustrates the geared motor 10 in an exploded illustration. The driving motor 25 is inserted in the housing part 16. The figure shows that the motor 25 and the housing part 16 are connected to each other by two screws 26, 27. The housing parts 16 and 17 are threaded to each other. Furthermore, the figure shows, that an output body 34 which is connected to the spindle 12 in a manner not illustrated specifically is installed in the gear mechanism.

The worm wheel 19 is equipped with three claws or 19 A, B, C which engage in corresponding intermediate spaces 34A, B, C of cylindrical porting of the output body 34. The claws 19 A, B, C may be part of the bushing 20. As a result, the parts can rotate relative to one another. If the torque is introduced by the worm wheel 19, the spring stress is reduced, and therefore the braking spring 21 can rotate freely at the same time. If, however, the torque is introduced by the output body 34, the braking spring 21 expands, thereby resulting in the braking effect.

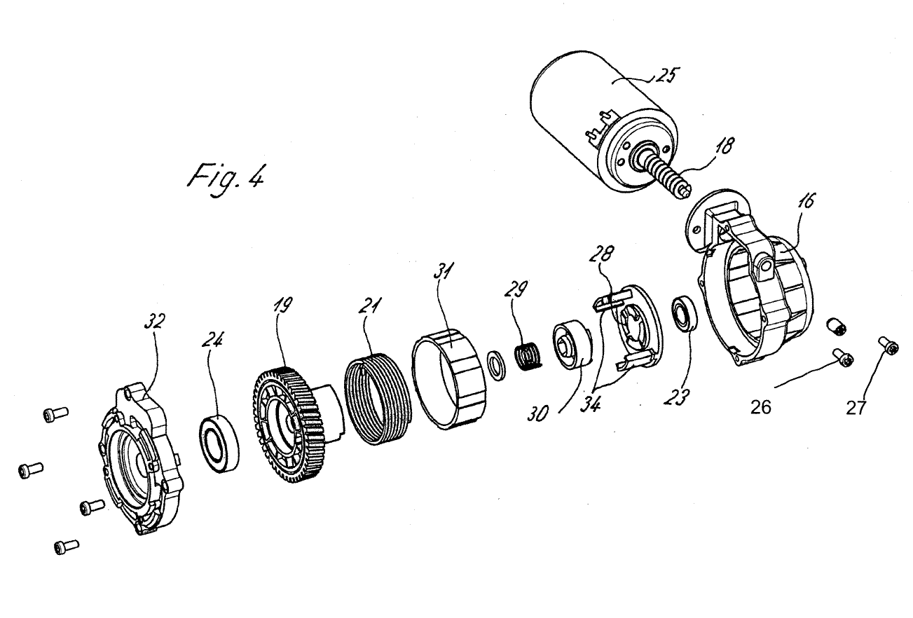

FIG. 4 shows an embodiment in which the gear mechanism is equipped not only with a load moment lock in the form of the braking spring 21 but the gear mechanism is also equipped with a free wheel such that a driving function is provided only in one rotational direction of the motor. For this purpose, the drive is also equipped with a further spring 29 and a free wheel ring 30. The claws or web 34 of the claw clutch 28 engage in a profiled ring 31 which is provided with longitudinal grooves on the outer circumference. The braking spring 21 is located within said profile ring 31. As the figure shows, the housing part 16 is screwed to the driving motor 25 by two screws 26, 27. The housing part 16 is closed by means of a connecting part in the form of a flange 32. The drive unit comprising the driving motor 25 and the gear mechanism could be connected to a further housing by means of the flange 32. Conversely, however, it is also possible for a further housing or a linear unit 11 to be fitted to the housing part 16.

The driving arrangement equipped with the geared motor can be equipped with a switchable free wheeling clutch or a switchable claw clutch in a manner not illustrated specifically. An actuating means is then provided which is operatively connected to at least one part of the claw clutch 28 or to at least one part of the free wheel ring 30. When the actuating means is actuated, the claws are disengaged, and therefore the driving connection with the driving motor 25 is disconnected. The actuation of the actuating means can take place or be transmitted by a manually actuable or by an electrically driven means.

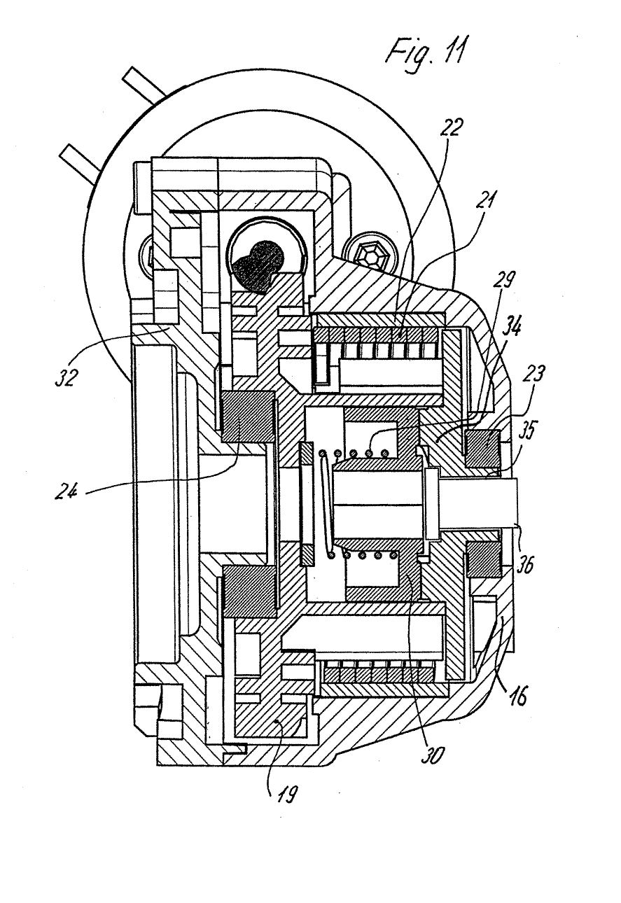

In a particularly simple embodiment, it is provided, according to FIG. 11, that the actuating means is a pin 36 which is inserted into a bore 35 of the output body 34 and into a bore of the housing part 16 in such a manner that it can be actuated from the outside of the housing part 16. In a preferred embodiment, the pin 36 is actuated by a compressive force. The bore 35 may lie in the axis of rotation of the output body 34. The diameter of the bore 35 may be slightly larger than the outside diameter of the pin 36. A generally known sealing means can then be inserted into said annular gap.

In the case of the geared motor 10, the latter can be considered a composite unit comprising the driving motor 25 and the gear stage or the gear mechanism. In this case, parts of the motor mounting or of the motor housing can be assigned to the gear housing 16, as seen in terms of operation. Such an embodiment is extremely cost-effective with regard to installation and the use of material. Such an embodiment could be based on the fact that the driving motor 25 no longer forms an independent functional unit.

The free wheel ring 30 has a profiled bore and forms the output element of the gear mechanism. The motor 25 and the gear mechanism may form a virtually common housing. By analogy, an open motor without an independent function is produced. The bearing bracket of the driving motor could be part of the housing for the gear mechanism.

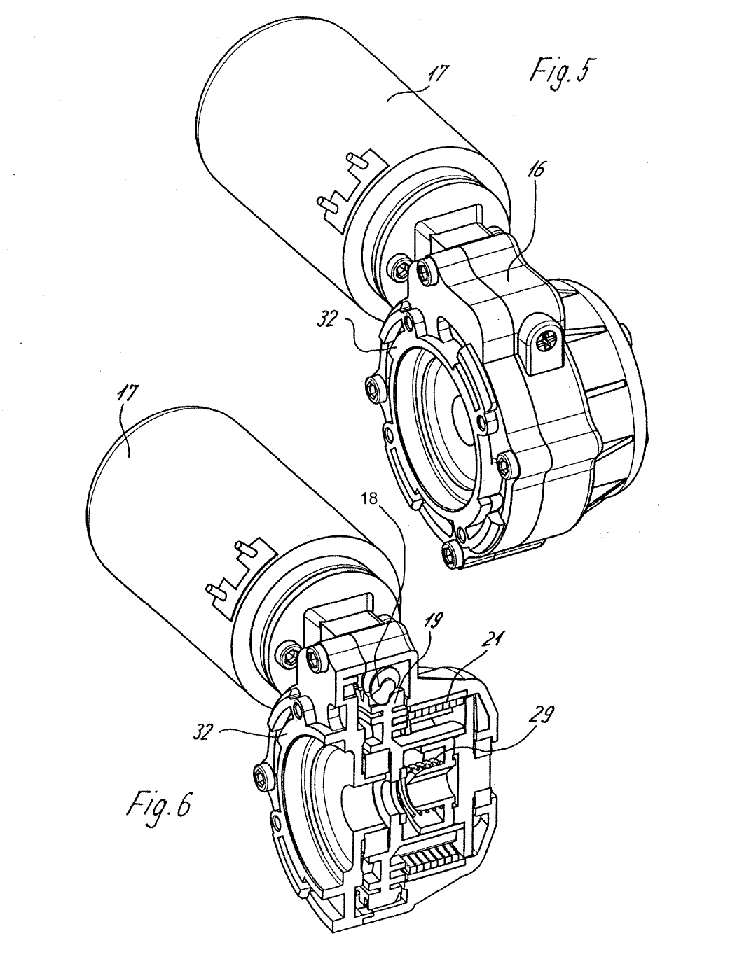

FIG. 5 shows the housing part 16 with the housing part 17, which is screwed to it, for the driving motor.

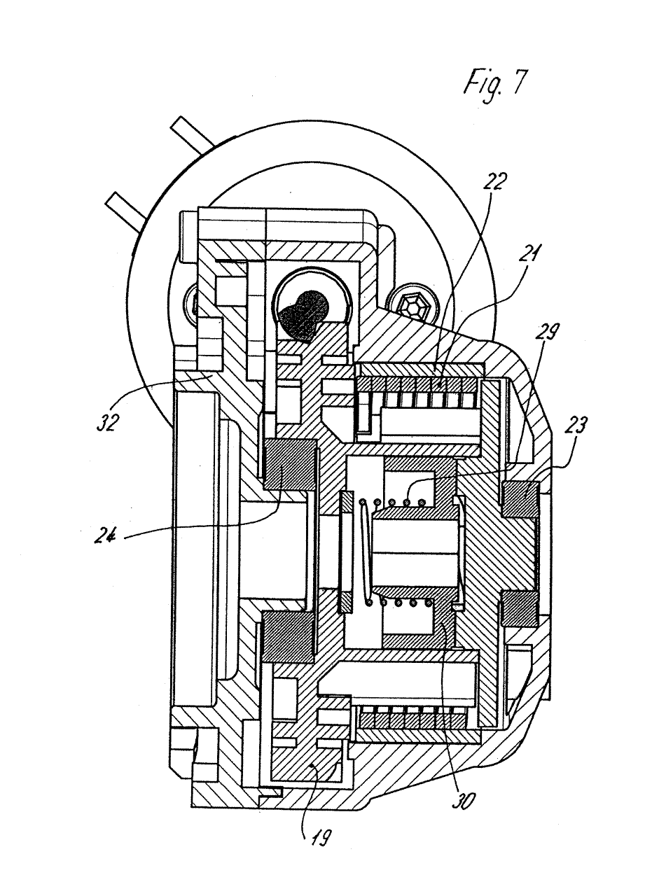

FIG. 6 shows the worm wheel 19 with a fitted collar over which the braking spring 21 is placed. This arrangement is also equipped with a free wheel and an inner spring 29. The gear stage is formed, in turn, from a worm 18 and the worm wheel 19. The arrangement according to FIGS. 5 to 6 could be used in a manner not illustrated specifically as a rotational drive, since the worm wheel 19 has a bore into which a driving element could be fixedly inserted. If, however, said driving element is a spindle, the driving arrangement is a linear drive.

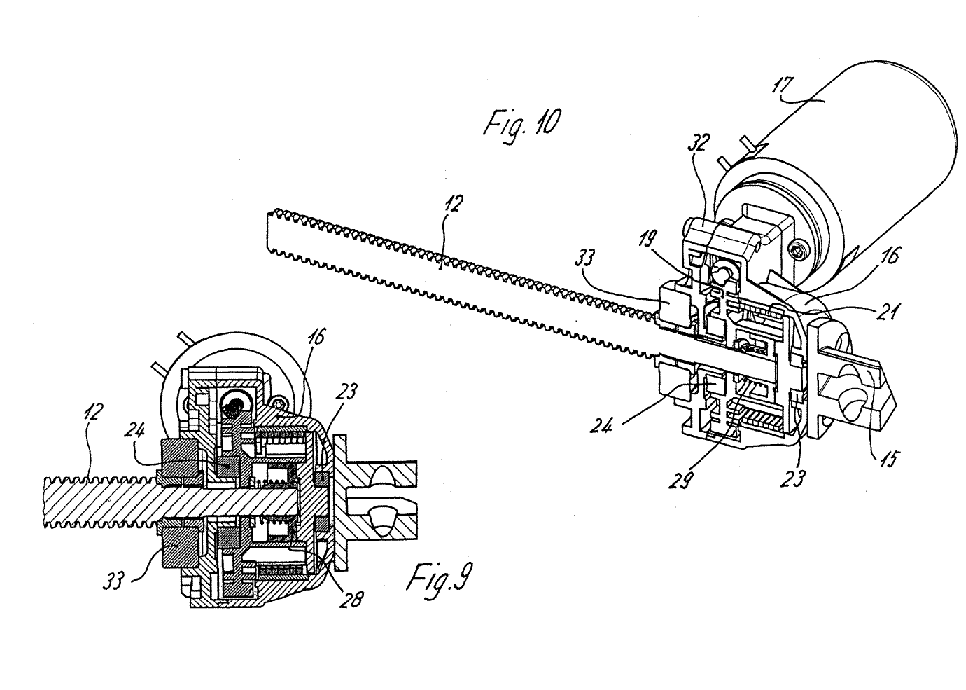

FIGS. 8 to 10 show a linear drive of this type, in which the worm wheel 19 drives the spindle 12. This arrangement is also equipped with a braking spring 21 and a further spring 29. This arrangement is also equipped with a claw clutch 28, and therefore the driving arrangement operates only in a certain rotational direction of the driving motor. The spindle 12 is mounted in a rolling contact bearing 33 which is fitted on the outside of the housing part 16 and could accordingly also be referred to as the gear mechanism bracket. A spindle nut is placed, in a manner not illustrated, onto the spindle 12 and is secured against rotation such that it is displaced in the longitudinal direction of the spindle 12 depending on the rotational direction of the driving motor. The spindle nut forms the output element of the driving arrangement.

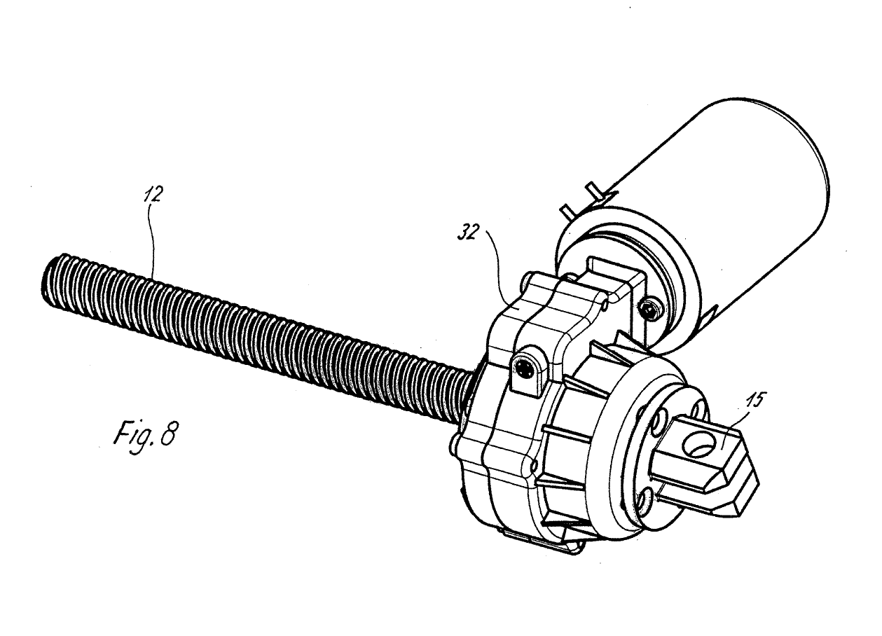

In FIGS. 2 to 7, the load moment lock is formed by a braking spring 21. The braking spring 21 is a helically coiled spring element which comprises a wire with an angular cross section. In this case, the wire ends are angled and are operatively connected to claws 19A, B, C of the driving body and of the output body 34. The driving body is designed here as a worm wheel 19 or as a bushing 20. The output body 34 has two claws which engage in the clearances between the claws 19A, B, C of the worm wheel 19 or of the bushing 20. The claws have a play in the circumferential direction, and therefore both parts can rotate relative to each other by a certain angle in relation to each other. In this case, the claws and the angled end regions of the braking spring 21 are designed in such a manner that the claws can advance to a position in front of the angled end regions of the braking spring 21.

If a torque is produced on the driving side, for example by means of the worm wheel 19, then the output body 34 is rotated by means of the claws. The claws here are shaped in such a manner that the frictional force between the braking spring 21 and the bushing 20 or the profiled ring 31 is reduced.

The output body 34 is operatively connected to the spindle 12 or to a profiled rod. If a torque is introduced on the output side into the output body 34, for example by the spindle 12, then the claws of the output body 34 act on the angled end regions of the braking spring 21 in such a manner that the frictional force between the braking spring 21 and the bushing 20 or the profiled ring 31 is increased.

A linear unit with a spindle, which is not self-locking, can be coupled to the gear mechanism or gear stage driven by the driving motor 25. If the fork head 14 is then moved manually, the free wheel is actuated by the too things being disengaged. The lifting tube of the linear unit can be pulled out by hand.

The worm 18 can be placed onto the motor shaft in a manner not illustrated specifically. The rotationally fixed connection can take place, for example, by adhesive bonding or pressing. Furthermore, it is possible for the motor shaft to be divided, but with a coupling again being required. This could also take place, for example, by means of the worm 18. One section of the motor shaft would then be assigned to the worm 18 and the other to the armature of the driving motor 25. The separation of the motor shaft could be located within or outside the housing.

The invention is not restricted to the exemplary embodiments illustrated. It is essential that a braking spring 21 which forms a load moment lock is integrated in the gear components forming the gear mechanism.

1. A geared motor for driving an adjusting device comprising, a driving motor; a gear driving arrangement including at least one gear stage, which is formed from gear components, for reducing the motor speed, and a mechanical load moment lock operatively connected to the gear stage; and a housing for the motor, a gear stage and moment lock.

2. A geared motor according to claim 1, wherein the load moment lock is operatively connected to an output element of the gear stage.

3. A geared motor according to claim 2, wherein the load moment lock is operatively connected to the output element of a first gear stage which is connected downstream of the driving motor.

4. A geared motor according to claim 1, wherein the load moment lock is designed as a spring element, preferably as a single-piece and annular spring element.

5. A geared motor according to claim 4, wherein the spring element is provided with a plurality of coils.

6. A geared motor according to claim 1, including one of a cylindrical attachment and at least two webs lying on a circle on an output element of the gear stage, and wherein the load moment lock is operative to the attachment.

7. A geared motor according to claim 1, the load moment lock is inserted into one ring and a bushing of a metallic material.

8. A geared motor according to claim 1, wherein an output element of the gear arrangement formed from the gear components is one of an output body, a spindle or a spindle nut placed onto a spindle.

9. A geared motor according to claim 1, including a respective rolling contact bearing arranged in the housing on both sides of an output element of the gear stage.

10. A geared motor according to claim 1, wherein the housing part includes two housing parts screwed to each other, and the driving motor is screwed to one of the housing parts.

11. A geared motor according to claim 1, wherein the housing includes a flange is fixed to a housing part which accommodates the gear components.

12. A geared motor according to claim 1, wherein the gear arrangement formed from the gear components includes a claw clutch.

13. A geared motor according to claim 1, characterized in that the gear arrangement formed from the gear components includes a free wheel.

14. A geared motor according to claim 1, wherein the housing of the geared motor is designed as a shaped part, with a plurality of shaped parts being connected to one another such that the gear housing is designed as a closed housing.

15. A geared motor according to claim 14, wherein the abutting surfaces of the shaped parts of the housing have sealing elements.

16. A geared motor according to claim 14, wherein the gear part of the housing comprises at least one web-like and open structure, with a plurality of structures being constructed and assembled in the form of a lattice.

17. A geared motor according to claim 16, including an additional housing which is preferably a closed housing is pulled over the housing constructed in the form of a lattice.

18. A geared motor according to claim 1, wherein the housing of the geared motor is provided with one of the attachments and recesses, and in that a further drive train can be fixed to the geared motor such that the geared motor can be fixed to an item of furniture or to a furniture component.

19. A geared motor according to claim 1, including a drive train, which is connected to the gear housing, is a spindle drive which is formed from at least one threaded spindle, a spindle nut placed thereon and a furniture component operatively connected to the spindle nut.

20. A geared motor according to claim 1, wherein and output element of the geared motor is provided with a profiled internal bore.

21. A geared motor according to claim 20, wherein the profiled internal bore is designed as one of an internal thread or as a polygonal profile.

22. A geared motor according to claim 20, wherein the housing of the geared motor is provided with at least one opening to receive one of a threaded spindle and a profiled rod which is operatively connected to the profiled internal bore of the output element of the geared motor.

23. A geared motor according to claim 1, including one of webs, forks, journals and recesses with transverse bores are fitted to/provided on or integrally formed on the gear housing of the geared motor such that the geared motor can be fixed on or in an item of furniture or on or in a furniture component.

24. A geared motor according to claim 1, including one of bores, recesses, pockets and journals on the gear housing of the geared motor such that, a drive train in the form of a spindle drive can be fixed to the housing.

25. A geared motor according to claim 1, wherein the load moment lock is formed by a driving body, an output body, a braking body and a frictional body.

26. A geared motor according to claim 25, wherein the driving body, the output body and the braking body are mounted in a rotating manner, and in that the frictional body is one of connected fixedly to the gear housing or is formed by a section of the gear housing.

27. A geared motor according to claim 25, the driving body is formed by a worm wheel and the braking body is formed by a braking spring with angled end regions, and in that the output body is operatively connected to a clutch, a threaded spindle, a profiled rod or a train of gears connected downstream.

28. A geared motor according to claim 25, wherein the outside diameter of the braking body is a little larger than the inside diameter of the frictional body, and therefore the braking body can be fitted to the frictional body with prestress.

29. A geared motor according to claim 25, wherein the driving body and the output body have claws which engage in one another and engage in one another with play in the rotational direction such that the driving body and the output body can move relative to each other by a certain angle.

30. A geared motor according to claim 29, wherein that the claws of the output body are operatively connected to surfaces of the angled end sections of the braking body in such a manner that, upon a rotation from the direction of the output element connected downstream of the output body, a reinforcement of the spring prestress takes place, thereby increasing the friction between the braking body and the frictional body.

31. A geared motor according to claim 1, wherein the contact surfaces between the claws of the driving body and/or of the output body and/or the contact surfaces with the angled end sections of the braking body are designed as metal inserts.

32. A geared motor according to claim 1, including a linear unit which has a spindle which is not self-locking is coupled to the gear stage of the geared motor.

33. A geared motor according to claim 1, including a worm on the motor shaft of the driving motor in a rotationally fixed manner.

34. A geared motor according to claim 33, wherein a shaft the motor is divided into two sections which are assigned to the worm and the armature of the driving motor respectively.
